(19) United States
(12) Patent Application Publication
(10) Pub. No.: US 2023/0085029 A1
(43) Pub. Date: Mar. 16, 2023

(54) APPARATUS USED IN AREAS WHERE ELECTROSTATIC DISCHARGE IS PREVENTED

(71) Applicants: Shigeo IWASA, Suginami-ku, Tokyo (JP); OTSUKA OPTICS CO., LTD., Shinagawa-ku, Tokyo (JP)

(72) Inventors: Shigeo Iwasa, Suginami-ku, Tokyo (JP); Taito Otsuka, Shinagawa-ku, Tokyo (JP)

(73) Assignees: Shigeo Iwasa, Suginami-ku, Tokyo (JP); OTSUKA OPTICS CO., LTD., Shinagawa-ku, Tokyo (JP)

(21) Appl. No.: 17/802,777

(22) PCT Filed: Feb. 5, 2021
(86) PCT No.: PCT/JP2021/004280

§ 371 Date: Aug. 26, 2022

(30) Foreign Application Priority Data
Feb. 28, 2020 (JP) 2020-032995

(51) Int. Cl. H05F 3/02

(52) U.S. Cl. CPC H05F 3/02

(57) ABSTRACT

An EPA apparatus (1) used in an area where electrostatic discharge is prevented includes: an earth terminal (10) including a plurality of terminal insertion holes (12), in which the earth terminal (10) is electrically conducted with a conductor component or an electrostatic dissipative component of a casing of the EPA apparatus (1), the plurality of terminal insertion holes (12) are electrically conducted with each other, at least one of the plurality of terminal insertion holes (12) is connected with an earth wire (41) grounded to an EPA ground through ground equipment, connection terminals of a banana terminal (52) and a banana terminal (62) of earth wires (51 and 61) connected from outside of the apparatus is inserted into the other terminal insertion holes (12).

### TECHNICAL FIELD

The present invention relates to an apparatus used in an area where electrostatic discharge is prevented.

### BACKGROUND ART

In an electrostatic discharge protected area (EPA), basically, an apparatus to be used is appropriately grounded using an antistatic product, thereby preventing static charges. For example, in order to release a charge charged to a human body to a ground-side electrode, a wristband (wrist strap) connected to the electrode with an earth wire is used (for example, see Patent Document 1). In a technique disclosed in Patent Document 1, ground wiring of the wristband is used commonly with the ground wiring of a conductive mat to simplify wiring equipment.

### RELATED DOCUMENT

### Patent Document

[Patent Document 1] Japanese Unexamined Patent Publication No.

### SUMMARY OF THE INVENTION

### Technical Problem

The antistatic product such as a wristband is connected to an earth terminal that is connected to the ground. Generally, the earth terminal is supplied as an independent product by itself. To install the earth terminal, it is required to screw the earth terminal to a workbench, and basically, the earth terminal is required almost as many as the number of workers because it is used for connecting the wristband, resulting in a problem of high cost. Further, when the earth terminal is installed on the workbench, there is a limitation in work range of a worker, resulting in a problem restriction in installation position of a measuring apparatus used by the worker.

In Patent Document 1, a socket is connected to the conductive mat by a hook, and the conductive mat and the wristband are commonly grounded. This is because a position of the hook is fixed, thus limiting the installation position of an apparatus (measuring apparatus, magnifier, or the like) introduced into the EPA, resulting in a problem of lack of convenience. In addition, when it is desired to ground the apparatus itself, the earth terminal has been already buried with a terminal of the wristband. In such a case, an additional measure is required, such as a need for installation of additional earth terminals or a need for an interrupt plug, resulting in a problem of increase in cost or labor. In addition, a space for installing the interrupt plug may not be secured, it is desirable that additional measures are not required as much as possible.

The present invention has been made in view of such a circumstance, and an object of the present invention is to provide a technique for facilitating grounding of an antistatic product or the like when working in an EPA.

### Solution to Problem

According to the present invention, an apparatus used in an area where electrostatic discharge is prevented includes:

an earth terminal including a plurality of connection terminals,

in which the earth terminal is electrically conducted with a conductor component or an electrostatic dissipative component of a body casing of the apparatus,

the plurality of connection terminals are electrically conducted with each other,

at least one of the plurality of connection terminals is connected with an earth wire grounded to an EPA ground through ground equipment,

the other terminal is connected with a connection terminal of an earth wire extending from another apparatus,

the apparatus is a magnifier attached to an arm,

the earth terminal is attached to a back side of the arm, and

the connection terminal is formed as a terminal insertion port that is open toward a back surface direction of the arm.

### Advantageous Effects of Invention

According to the present invention, it is possible to provide a technique for facilitating grounding of an antistatic product or the like when working in an EPA.

### BRIEF DESCRIPTION OF THE DRAWINGS

FIG. 1 is a diagram showing an EPA apparatus according to a first embodiment.

FIG. 2 is a diagram showing an earth terminal provided on a side surface of the EPA apparatus according to the first embodiment.

FIG. 3 is a diagram showing an arm-type illumination magnifier according to a second embodiment.

FIG. 4 is a perspective view showing an illumination magnifier according to a third embodiment.

FIG. 5 is a side view (partial cross-sectional view) showing the illumination magnifier according to the third embodiment.

FIG. 6 is a plan view (partial cross-sectional view) showing the illumination magnifier of the third embodiment.

### DESCRIPTION OF EMBODIMENTS

### Overview of Embodiments

In the following embodiments, an earth terminal is assembled to an apparatus (measuring device, magnifier, or the like) introduced into an electrostatic discharge protected area (EPA), and earth wires are aggregated and connected to an EPA ground by the earth terminal. Hereinafter, the embodiments will be described in detail.

### First Embodiment

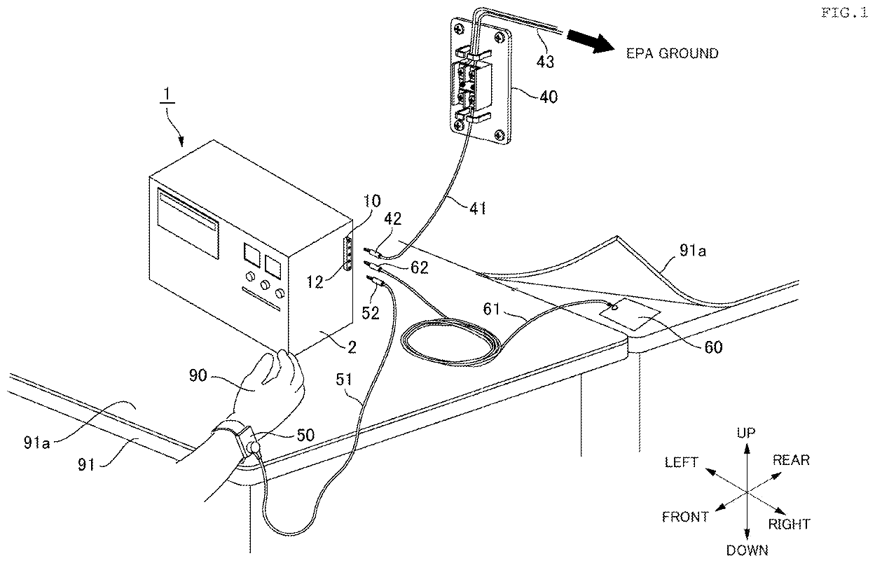

FIG. 1 is a diagram showing an EPA apparatus 1 according to the present embodiment. Here, the EPA apparatus 1 is installed in a predetermined workroom designated and operated in the electrostatic discharge protected area (EPA). An EBP 40 is installed on a wall surface of the workroom.

The EBP 40 is a ground connection point that conforms to a specification of the EBP (ground connection point) required by standards of static electricity countermeasure (RCJS), and collects and manages many earth routes present in the ESD protected area (EPA). Specifically, an EPA ground wire 43 connected to the EPA ground and an earth wire 41 connected to the EPA apparatus 1 are connected to the EBP 40.

The EPA apparatus 1 includes an earth terminal 10 on a side surface 2 of the apparatus (that is, side surface of a casing), and is disposed on a workbench 91 installed in the EPA. A worker wears a wrist strap 50 as an antistatic product on a his/her hand (wrist) 90, and connects the wrist strap 50 to the EBP 40 through the earth terminal 10. As a result, it is possible to prevent the worker from getting charged and to quickly release the charged charge to the earth.

A conductive rubber mat 91a is provided on an upper surface of the workbench 91. The EPA apparatus 1 having a predetermined measurement function is placed on the conductive rubber mat 91a. An earth plate 60 to which one end of the earth wire 61 is connected is placed between the workbench 91 and the conductive rubber mat 91a, and is connected to the EBP 40 through the earth terminal 10.

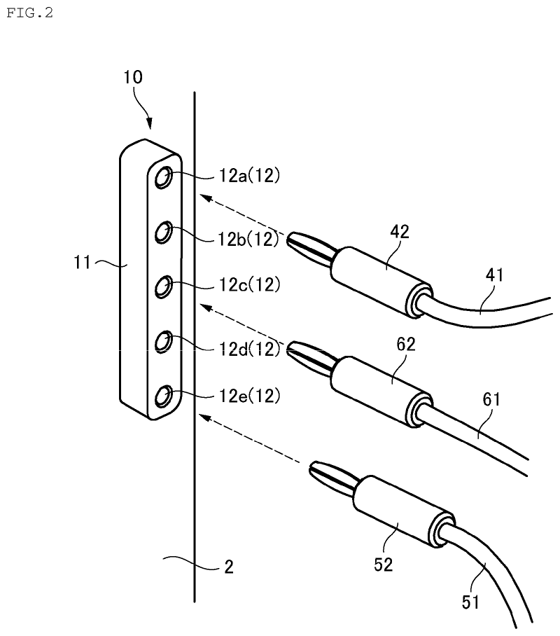

FIG. 2 is an enlarged diagram showing the earth terminal 10 in FIG. 1. The earth terminal 10 has a vertically-long substantially rectangular parallelepiped shape, and is vertically attached to the side surface 2 of the apparatus. The earth terminal 10 includes a terminal main body 11 and a plurality of terminal insertion ports provided in the terminal main body 11. For example, the terminal main body 11 is formed by processing a metal (more specifically, pure metal) of a conductor, such as brass or aluminum (or an alloy thereof) into a predetermined shape. The terminal main body 11 is electrically conducted with a conductor component or an electrostatic dissipative component of the body casing of an EPA apparatus.

A plurality of terminal insertion holes 12 are provided in a top surface of the terminal main body 11 (that is, a surface opposite to a surface attached to the terminal main body 11), and for example, banana terminals 42, 52, and 62 can be inserted thereinto. Here, first to fifth terminal insertion holes 12a to 12e are formed in order from the top.

The terminal main body 11 is made of a metal of a conductor, and the first to fifth terminal insertion holes 12a to 12e have the same shape and function as each other and are electrically conducted with each other. Therefore, the banana terminals 42, 52, and 62 (that is, earth wires 41, 51, and 61) inserted into one terminal insertion hole 12 of the first to fifth terminal insertion holes 12a are conducted with the banana terminals 42, 52, and 62 (that is, earth wires 41, 51, and 61) of the other terminal insertion hole 12. Since one of the first to fifth terminal insertion holes 12a to 12e needs to be directly or indirectly connected to the EBP 40 (that is, EPA ground), it is desired to indicate that a specific terminal insertion hole 12 (for example, first terminal insertion hole 12a at the top) is the terminal insertion hole 12 connected to the EBP 40 (that is, EPA ground).

In FIG. 2, the banana terminal 42 of the earth wire 41 that extends from the EBP 40 is inserted into the first terminal insertion hole 12a at the top. The banana terminal 62 of the earth wire 61 that can extend from the earth plate 60 is inserted into the third terminal insertion hole 12c in the middle. Further, the banana terminal 52 of the earth wire 51 that extends from the wrist strap 50 is inserted into the fifth terminal insertion hole 12e at the bottom.

In this manner, the earth terminal 10 attached to the EPA apparatus 1 aggregates the earth wires 41, 51, and 61 from the casing of the EPA apparatus 1 itself or surrounding antistatic products (that is, the wrist strap 50 worn by the worker and the earth plate 60 disposed on the workbench 91). The aggregated earth wires 41, 51, and 61 are connected to the EBP 40 and finally grounded to the EPA ground. As a result, it is possible to suppress installation construction of additional EBP 40 which is liable to be insufficient or the earth terminal from being attached to the workbench 91 alone. Further, it is possible to prevent wirings of the earth wires 41, 51, and 61 from being complicated. Moreover, there is no limitation in installation position of the EPA apparatus 1 because the earth terminal 10 is provided on the EPA apparatus 1 used by the worker.

By setting the number of terminal insertion holes 12 of the earth terminal 10 to two or more as described above, not only connection between the EPA apparatus 1 and an earth (earth plate 60) of the workbench or the like or the wrist strap 50, but also connection between products (that is, a plurality of EPA apparatuses 1) having an earth terminal for apparatus assembly can be made, thereby grounding the earth wires to the EPA ground through the EBP 40.

A surface of the earth terminal 10 may be coated to have a surface resistance (for example, 10⁵Ω or more and 10¹¹Ω or less) of a level that electrostatic discharge is not caused while preventing charges, or a cover controlled at such a surface resistance may be attached to the surface of the earth terminal 10. An example of the cover will be described later in the third embodiment. In addition, connection between the earth terminal 10 and the earth wires 41, 51, and 61 is not limited to connection between the earth terminal 10 and the banana terminals 42, 52, and 62 through the terminal insertion hole 12, and other connection forms such as screw fixing and magnet fitting may be used.

As described above, the first embodiment is summarized as follows.

(1) An EPA apparatus 1 used in an area where electrostatic discharge is prevented includes:

an earth terminal 10 including a plurality of terminal insertion holes 12 (connection terminals),

in which the earth terminal 10 is electrically conducted with a conductor component or electrostatic dissipative component of the casing in the EPA apparatus 1,

the plurality of terminal insertion holes 12 are electrically conducted with each other,

at least one of the plurality of terminal insertion holes 12 (the first terminal insertion hole 12a in the present embodiment) is connected to an earth wire 41 grounded to an EPA ground through ground equipment, and

other apparatuses (a wrist strap 50, earth plate 60, or connection terminals (the banana terminal 52 of the earth wire 51, the banana terminal 62 of the earth wire 61, and the like) are inserted into the other terminal insertion holes 12 (the second to fifth terminal insertion holes 12b to 12e in the present embodiment) connected from another EPA apparatus (not shown).

(2) The earth terminal 10 is formed to have the terminal insertion hole 12 that is directly provided on a metal ingot (for example, aluminum, brass, or stainless steel). For example, the terminal insertion hole 12 is formed by making a hole through cutting.

### Second Embodiment

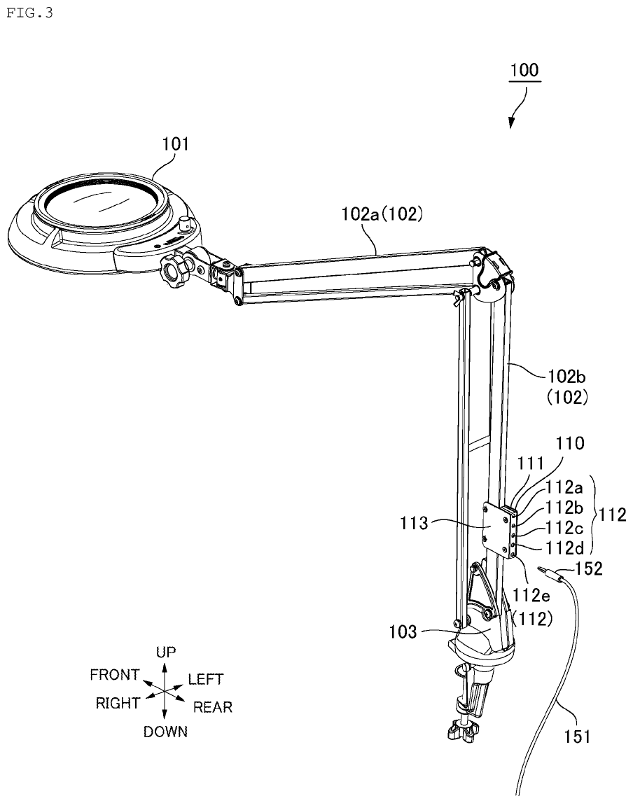

FIG. 3 is a perspective view of an arm-type illumination magnifier 100 according to the present embodiment, when viewed from a back side.

As shown in FIG. 3, the arm-type illumination magnifier 100 includes a lens head 101, an arm 102, an arm stand (clamp type) 103, and an earth terminal 110. The arm 102 has a first arm 102a to which the lens head 101 is attached and a second arm 102b to which the arm stand (clamp type) 103 is attached.

The lens head 101 is attached to a tip of the arm 102 (first arm 102a).

The arm stand (clamp type) 103 is attached to the arm 102 (second arm 102b). The arm 102 is fixed to a workbench or the like (for example, the workbench 91 shown in FIG. 1) by the arm stand (clamp type) 103.

The earth terminal 110 is attached to a back side of the arm 102. Similar to the first embodiment, the earth terminal 110 includes the terminal main body 111 formed of a metal of a conductor in a predetermined shape and the plurality of terminal insertion holes 112, and is attached to the arm 102 by a fixing plate 113. In the present embodiment, on the second arm 102b of the arm 102, the earth terminal 110 is attached immediately close to the arm stand (clamp type) 103.

As shown in FIG. 3, first to fifth terminal insertion holes 112a to 112e are provided as the plurality of terminal insertion holes 112. The first to fifth terminal insertion holes 112a to 112e are open toward the back side of the arm-type illumination magnifier 100 (second arm 102b) in a state in which the earth terminal 110 is attached to the second arm 102b. The banana terminal 152 is provided at one end of the earth wire 151 extending from an EBP, an antistatic product, or an EPA apparatus, and is connected to the first to fifth terminal insertion holes 112a to 112e.

When using the arm-type illumination magnifier 100 of the second embodiment, the earth wire 151 can be aggregated and the EPA ground can be grounded through the EBP, similar to the first embodiment. As a result, it is possible to suppress installation construction of additional EBP 40 or a single earth terminal from being individually attached to the workbench or the like. Further, it is possible to prevent wirings of the earth wires 151 from being complicated. Moreover, since the earth terminal 110 is provided on the arm-type illumination magnifier 100 used by the worker, an installation position of the arm-type illumination magnifier 100 is not limited by a working position of the worker (that is, a distance from the wrist strap) or a position of a single earth terminal installed individually. Further, in the present embodiment, since on the second arm 102b, the earth terminal 110 is attached immediately close to the arm stand (clamp type) 103 in a direction of an opening of the terminal insertion hole 112 as the back side, even when the position of the lens head 101 is changed, the earth wire 151 attached to the earth terminal 110 is significantly moved. That is, the work is not hindered by the movement of the earth wire 151.

### Third Embodiment

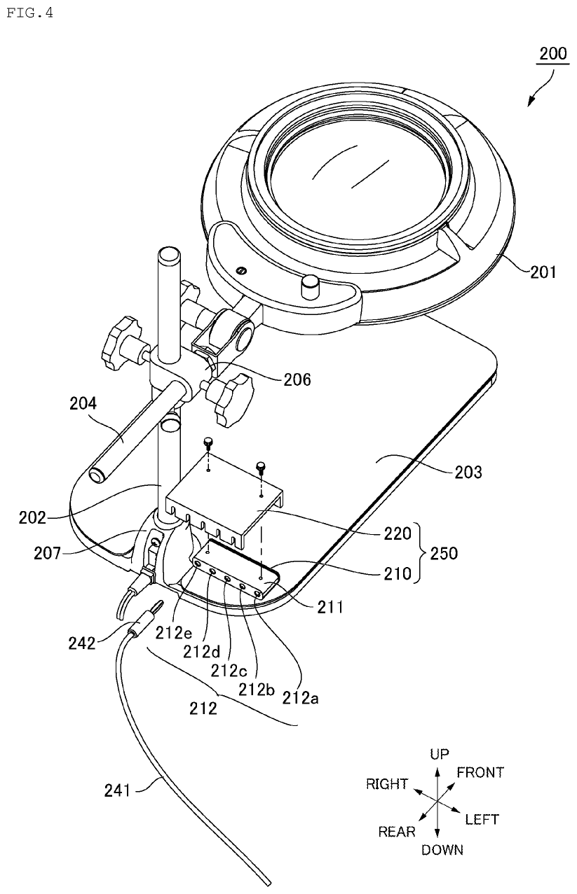

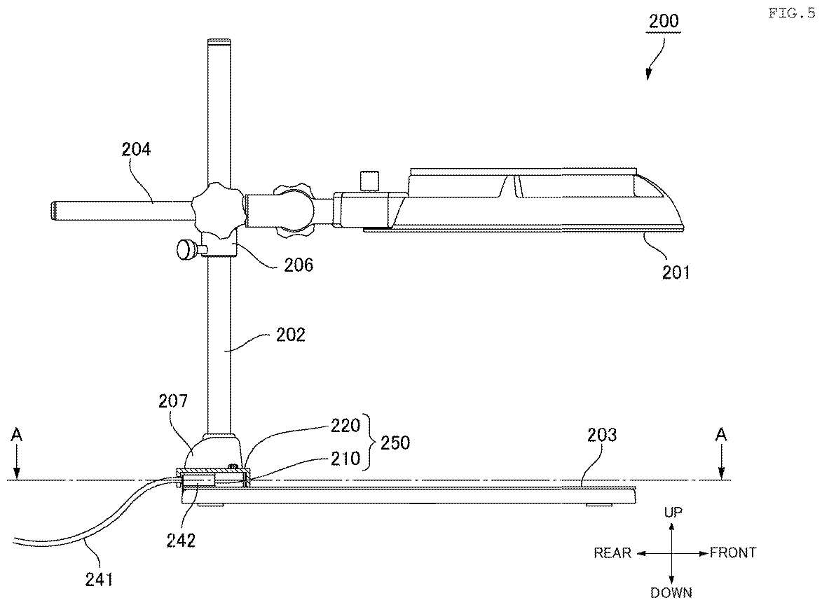

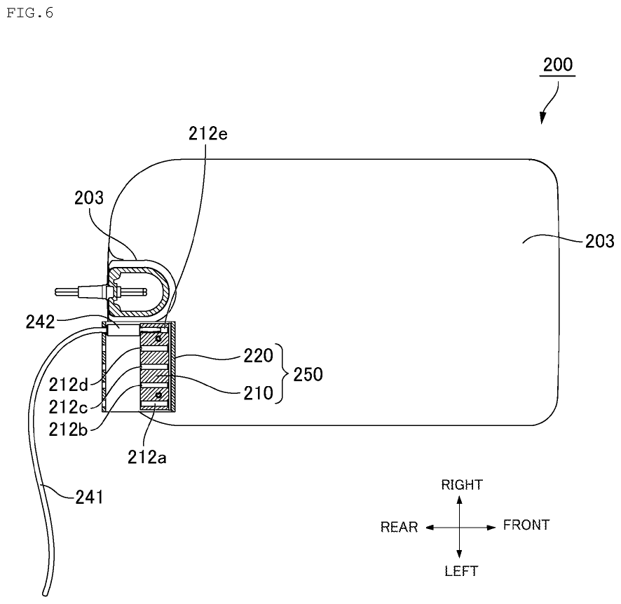

An illumination magnifier 200 (stand base-type loupe) of a third embodiment will be described with reference to FIGS. 4 to 6. FIG. 4 is a perspective view of the illumination magnifier 200 when viewed from a back side of the illumination magnifier 200, FIG. 5 is a side view of the illumination magnifier 200, and FIG. 6 is a cross-sectional view taken along line A-A in FIG. 5.

The illumination magnifier 200 includes a workbench 203, a pole 202 erected from the workbench 203, and a lens head 201 connected to the pole 202 by a support arm 204 through a joint 206. The lens head 201 includes a lens unit having a lens housed in a rubber lens frame and a lens holder housing the lens unit, and the lens holder is provided with an illuminating device illuminating the workbench 203. In addition, the lens head 201 can be positioned up, down, front, and rear by the joint 206. A stand part 207 is provided in a rear center of the workbench 203, and the pole 202 is erected from the stand part 207.

An earth terminal unit 250 is provided immediately next to the stand part 207. The earth terminal unit 250 includes an earth terminal 210 and a terminal cover 220.

Similar to the first and second embodiments, the earth terminal 210 includes a rectangular parallelepiped terminal main body 211 made of a metal and a terminal insertion hole 212 formed in the terminal main body 211. One end of the earth wire 241 is connected to an EBP, an antistatic product, or the like, and a banana terminal 242 is provided at the other end.

The terminal insertion hole 212 is composed of first to fifth terminal insertion holes 212a to 212e capable of inserting the banana terminals 242 thereinto, and the first to fifth terminal insertion holes 212a to 212e face an opening on a rear side. Therefore, when the banana terminal 242 is inserted into the first to fifth terminal insertion holes 212a to 212e, it is inserted forward from the rear side of the illumination magnifier 200. Therefore, it is possible to prevent the earth wire 241 connected to the banana terminal 242 from interfering with the work on the workbench 203.

Further, the terminal cover 220 is provided to cover the earth terminal 210. The terminal cover 220 is coated to have a surface resistance (for example, 10⁵Ω or more and 10¹¹Ω or less) of a level that electrostatic discharge is not caused while preventing charges, or is made of a resin controlled at such a surface resistance.

In the back side of the terminal cover 220, a wiring opening through which the earth wire 241 passes is formed in a recessed shape from a lower side, at a position corresponding to the first to fifth terminal insertion holes 212a to 212e. In addition, a depth of the terminal cover 220 is a length to include and cover the banana terminal 242 inserted into the terminal insertion hole 212. This can prevent the earth wire 241 or the banana terminal 242 from coming off. Further, by making the screw fixing position adjustable, the terminal cover 220 can be attached so that the banana terminal 242 is pressed against the inner surface of the terminal cover 220.

The banana terminal 242 is inserted into the terminal insertion holes 212 (first to fifth terminal insertion holes 212a to 212e), and the terminal main body 211 is fixed by screws or the like by being covered with the terminal cover 220 from a top.

Hereinabove, according to the third embodiment, the earth wire 241 can be aggregated and the EPA ground can be grounded through the EBP, similar to the first and second embodiments. As a result, it is possible to suppress installation construction of additional EBP or a single earth terminal from being individually attached to the workbench or the like. Further, it is possible to prevent wirings of the earth wires 241 from being complicated. Moreover, since the earth terminal 210 is provided on the illumination magnifier 200 used by the worker, an installation position of the illumination magnifier 200 is not limited by a working position of the worker (that is, a distance from the wrist strap) or a position of a single earth terminal installed individually. Further, in the present embodiment, the earth terminal 210 is provided immediately next to the pole 202 that is erected from the rear side of the workbench 203, more specifically, immediately next to the stand part 207, and the earth wire 241 is wired at the rear side. Therefore, it does not interfere with an inspection of an object to be inspected that is placed on the workbench 203.

Further, the terminal main body 211 is made of a metal, and good conduction is taken between equipment (EBP, antistatic product, or EPA apparatus) connected to the terminal insertion hole 212. Moreover, because the terminal main body 211 is covered with the terminal cover 220 at the surface resistance described above, suitable static charge can be prevented, and destruction of the object to be inspected due to the ESD can be prevented, or adhesion of dust or foreign substances as a cause of the static charge can be effectively prevented.

Although the embodiments of the present invention have been described with reference to drawings, these are mere examples of the present invention, and various other configurations (modifications) other than those given above may be adopted.

Priority is claimed on Japanese Patent Application No. 2020-032995, filed Feb. 28, 2020, the content of which is incorporated herein by reference.

### REFERENCE SIGNS LIST

1: EPA apparatus
2: side surface of apparatus
10, 110, 210: earth terminal
11, 111, 211: terminal main body
12, 112, 212: terminal insertion hole
40: E B P EBP
41, 51, 61, 151, 241: earth wire
42, 52, 62, 152, 242: banana terminal
43: EPA ground wire
50: wrist strap
60: earth plate
91: workbench
91a: conductive rubber mat
100: arm type illumination magnifier
101: lens head
102: arm
200: illumination magnifier
201: lens head
202: pole
203: workbench
204: support arm
206: joint
207: stand part
220: terminal cover
250: earth terminal unit

1. An apparatus used in an area where electrostatic discharge is prevented, comprising:
an earth terminal including a plurality of connection terminals,
wherein the earth terminal is electrically conducted with a conductor component or an electrostatic dissipative component of a body casing of the apparatus,
the plurality of connection terminals are electrically conducted with each other,
at least one of the plurality of connection terminals is connected with an earth wire grounded to an EPA ground through ground equipment,
the other terminal is connected with a connection terminal of an earth wire extending from another apparatus,
the apparatus is a magnifier attached to an arm,
the earth terminal is attached to a back side of the arm, and
the connection terminal is formed as a terminal insertion port that is open toward a back surface direction of the arm.

2. An apparatus used in an area where electrostatic discharge is prevented, comprising:
an earth terminal including a plurality of connection terminals,
wherein the earth terminal is electrically conducted with a conductor component or an electrostatic dissipative component of a body casing of the apparatus,
the plurality of connection terminals are electrically conducted with each other,
at least one of the plurality of connection terminals is connected with an earth wire grounded to an EPA ground through ground equipment,
the other terminal is connected with a connection terminal of an earth wire extending from another apparatus,
the apparatus is a magnifier that has a workbench and a pole erected from the workbench,
the earth terminal is provided in the vicinity of an erecting position of the pole, and
the connection terminal is formed as a terminal insertion port that is open toward a back surface direction.

3. The apparatus according to claim 1,
wherein the earth terminal is formed to have the connection terminal that is directly provided on a metal ingot.

4. An apparatus used in an area where electrostatic discharge is prevented, comprising:
an earth terminal including a plurality of connection terminals,
wherein the earth terminal is electrically conducted with a conductor component or an electrostatic dissipative component of a body casing of the apparatus,
the plurality of connection terminals are electrically conducted with each other,
at least one of the plurality of connection terminals is connected with an earth wire grounded to an EPA ground through ground equipment,
the other terminal is connected with a connection terminal of an earth wire extending from another apparatus, and
the earth terminal is formed to have the connection terminal that is directly provided on a metal ingot.

5. The apparatus according to claim 1, further comprising:
a cover covering the earth terminal.

6. The apparatus according to claim 5,
wherein a surface resistance of the cover is 1×10⁵ to 1×10¹¹Ω.

7. The apparatus according to claim 2,
wherein the earth terminal is formed to have the connection terminal that is directly provided on a metal ingot.

8. The apparatus according to claim 2, further comprising:
a cover covering the earth terminal.

9. The apparatus according to claim 8,
wherein a surface resistance of the cover is 1×10⁵ to 1×10¹¹Ω.

10. The apparatus according to claim 3, further comprising:
a cover covering the earth terminal.

11. The apparatus according to claim 10,
wherein a surface resistance of the cover is 1×10⁵ to 1×10¹¹Ω.

12. The apparatus according to claim 4, further comprising:
a cover covering the earth terminal.

13. The apparatus according to claim 12,
wherein a surface resistance of the cover is 1×10⁵ to 1×10¹¹Ω.

14. The apparatus according to claim 7, further comprising:
a cover covering the earth terminal.

15. The apparatus according to claim 14,
wherein a surface resistance of the cover is 1×10⁵ to 1×10¹¹Ω.
